(19) United States
(12) Patent Application Publication
(10) Pub. No.: US 2013/0283671 A1
(43) Pub. Date: Oct. 31, 2013

(54) DEVICES AND METHODS FOR DETECTING AND TRAPPING PESTS

(71) Applicants: Darek Czokajlo, West Linn, OR (US); Aubrey Moore, West Linn, OR (US)

(72) Inventors: Darek Czokajlo, West Linn, OR (US); Aubrey Moore, West Linn, OR (US)

(21) Appl. No.: 13/458,616

(22) Filed: Apr. 27, 2012

(51) Int. Cl. A01M 1/04; A01M 1/10; A01M 1/14

(52) U.S. Cl. 43/113; 43/114

(57) ABSTRACT

Pest detecting and trapping devices, including insect-trapping sheets defining adhesive surfaces, light sources supported proximate the adhesive surfaces, and power sources configured to deliver power to the light sources. In some examples, pest detecting and trapping devices may be particularly tailored to monitor pest activity within shipping containers during transit. Additionally, this disclosure discusses methods of detecting and trapping pests in shipping containers by providing pest detecting and trapping devices, placing the pest detecting and trapping devices within the shipping containers, and manipulating the pest detecting and trapping devices into closed configurations after passages of time.

### BACKGROUND

The present disclosure relates generally to pest detecting and trapping devices, and methods implementing the same. In particular, this disclosure describes devices used to detect and trap pests in shipping containers during transit.

The need for efficient pest detecting and trapping systems designed for use in shipping containers is well understood. Transporting goods with shipping containers is a pillar of world trade, and this dependence makes measures to maintain the integrity of shipping containers of prime importance. For example, implementing effective pest detecting and trapping systems in shipping containers may provide lower shipping costs and greater quality assurance of the contained goods. As dependence on shipping containers grows, the need for effective devices and methods to detect pests grows even greater.

Known pest monitoring systems for shipping containers, however, are not entirely satisfactory. For example, many shippers currently monitor hitchhiker pests by directly inspecting the shipping containers upon arrival. Because many pests may be hidden in hard to see areas while the shipping container is inspected, manually inspecting shipping containers for pests can be time consuming and imprecise. This problem is compounded by the fact that many pests are so small that they are difficult to discern from their surroundings with the naked eye.

Because directly inspecting shipping containers is a time-consuming process, it may increase the total cost of shipping and increase shipping times. Thus, there exists a need for more accurate and less time consuming methods to trap and detect pests as an alternative to directly inspecting shipping containers.

Additionally or alternatively, known pest trapping devices often ineffectively implement light sources to lure and trap pests in a non-destructive manner. Conventional traps implementing a light source as a lure, such as common electric zapper type traps, often damage and degrade pests beyond recognition. Destroying the pests sought to be detected diminishes the effectiveness of the trap as a means to trap and detect pests.

In other cases, known traps do not space light sources from a trapping region, which tends to reduce the rate at which lured pests are trapped. Additionally or alternatively, many light sources lures are not tuned to wavelengths or intensities that are particularly useful in targeting certain pests.

Conversely, many non-destructive traps, such as those with adhesive surfaces, rely on species-specific lures, such as chemical attractants and pheromones. Because these traps are species dependent, they are not satisfactorily effective at capturing a wide range of pest species. This problem is magnified when there is a great potential for unexpected species of pests, a problem particularly relevant to the shipping container context. Species dependent traps are particularly troublesome in shipping container contexts where the precise species of hitchhiker pests is unpredictable and varied.

Even with conventional pest detecting and trapping systems that are non-destructive, few provide a simple way to store the trapped pests and transport them for analysis. Most currently-available detecting and trapping systems do not provide means for storing pests exactly as they are trapped and transporting the stored pests for analysis in that state. In contrast, the most common method for detecting pests in a shipping context, directly inspecting shipping containers, provides no ready means for collecting physical pest data. Well preserved physical pest samples is useful for archiving pest samples from shipping containers and for obtaining second opinions on the identity of a detected pests. Relying solely on an inspector's assessment of pest identity in the field poses a risk of acquiring faulty data due to inspector error.

Thus, there exists a need for improved pest trapping devices and methods. In particular, society would benefit from improved pest trapping devices and methods that utilize light source lures and provide an elegant solution for storing, transporting, and analyzing trapped pests.

### SUMMARY

The present disclosure discusses including insect-trapping sheets defining adhesive front surfaces, light sources engaged with the front surfaces, and power sources configured to deliver power to the light sources. In some examples, pest detecting and trapping devices may be particularly tailored to monitor pest activity within shipping containers during transit. Additionally, this disclosure discusses methods of detecting and trapping pests in shipping containers by providing pest detecting and trapping devices, placing the pest detecting and trapping devices within the shipping containers, and manipulating the pest detecting and trapping devices into closed configurations after passages of time.

### BRIEF DESCRIPTION OF THE DRAWINGS

FIG. 1 is a perspective view of a first example of a pest detecting and trapping device.

FIG. 2 is a front elevation view of the device shown in FIG. 1 in use within a shipping container.

FIG. 3 is a rear elevation view of the device shown in FIG. 1.

FIG. 4 is a perspective view of an adhesive sheet included in the device shown in FIG. 1.

FIG. 5 is a rear perspective view of the adhesive sheet shown in FIG. 5.

FIG. 6 is a perspective view of a second example of a pest detecting and trapping device in use.

FIG. 7 is a flowchart depicting a method of detecting and trapping pests in a shipping container.

FIG. 8 is a perspective view of an example of a pest detecting and trapping device including a sheet, a power source, and a light source independent of a container.

### DETAILED DESCRIPTION

The disclosed pest detecting and trapping devices and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various pest detecting and trapping devices and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

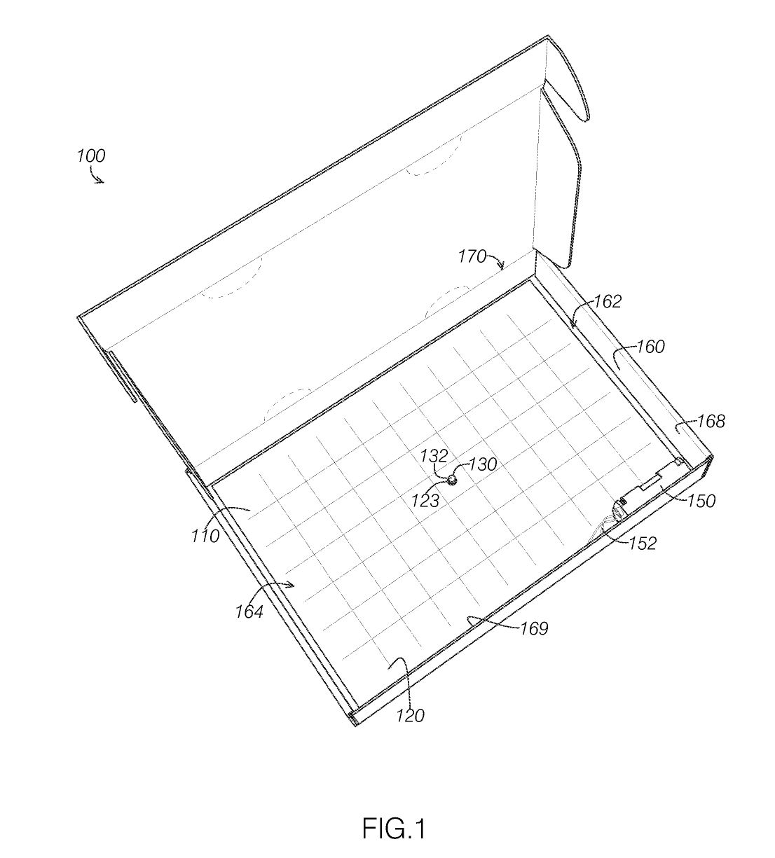

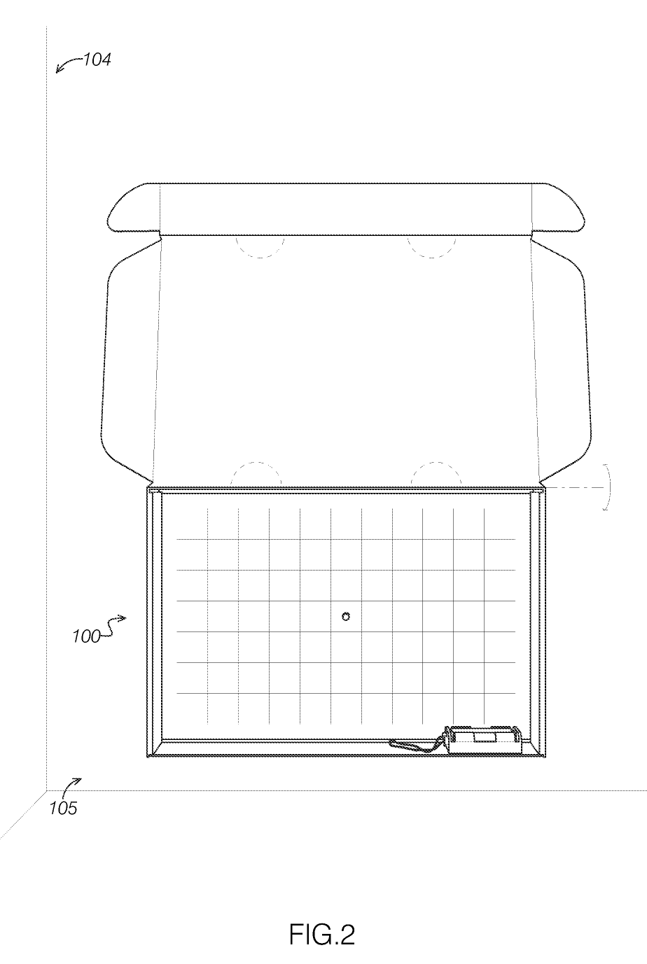

With reference to FIGS. 1-5, a first example of a pest detecting and trapping device, pest detecting and trapping device 100, will now be described. As FIG. 1 illustrates, pest detecting and trapping device 100 includes a container 160, a sheet 110, a light source 130, a wire 152, and a power source 150. FIG. 2 illustrates an example context where pest detecting and trapping device 100 is in use in a shipping container 104.

Pest detecting and trapping device 100 has many functions that may provide benefits over similar devices. For example, pest detecting and trapping device 100 includes a light source 130 engaged with an adhesive sheet providing a non-destructive trapping surface. Light source 130 serves to lure pests to a non-destructive trapping surface. Engaging light source 130 directly to adhesive surface 120 has been observed, in some circumstances, to increase the rate at which pests lured by light source 130 are trapped, producing more accurate pest detection data.

The nondestructive trapping surface limits damage to captured pests. Limiting damage to captured pests helps maintain their integrity to make it easier for inspectors to later detect and identify them, in contrast to many lighted electric “zapper”-type pest control systems. Because trapped pests remain in a substantially recognizable form, incidence data may be drawn from the trapping surfaces, including both the quantity and types of trapped pests.

In some examples, the pest detecting and trapping device is incorporated, fixedly or removably, within a transport container. The transport container enables a user to readily ship the device and any pests trapped within the device to a remote location, such as a laboratory or certification station, without requiring supplemental packaging materials. The transport container may optionally provide space for logging data in an externally accessible position, allowing a user to perform sorting and analysis tasks without opening the transport container.

This disclosure specifically contemplates using disclosed pest detecting and trapping devices in shipping containers to monitor pest activity during transit. Applicants have observed unexpected benefits from using light-sources as a pest lure or attractant in shipping containers. When used in such contexts, the disclosed pest detecting and trapping devices advantageously lure and trap pests for substantially the entire duration of transit. By luring and trapping pests over an extended period of time, the disclosed devices provide effective and efficient means for trapping pests in shipping containers to be later analyzed and cataloged. Indeed, the disclosed devices and methods for trapping and detecting pests have been observed to be more effective and efficient than conventional techniques, such as inspecting shipping containers for unrestricted pests after the shipping container arrives at a given location.

Indeed, many features of the devices described herein may be particularly useful when using the disclosed devices in a shipping context. For example, pest detecting and trapping device 100 may easily be added to a shipping container at a departure location and then easily removed from the shipping container upon arrival at a destination location. At the destination location, pests trapped by device 100 en route can readily be inspected by an inspector in place of manually inspecting the shipping container for evidence of pests, which is a time consuming process.

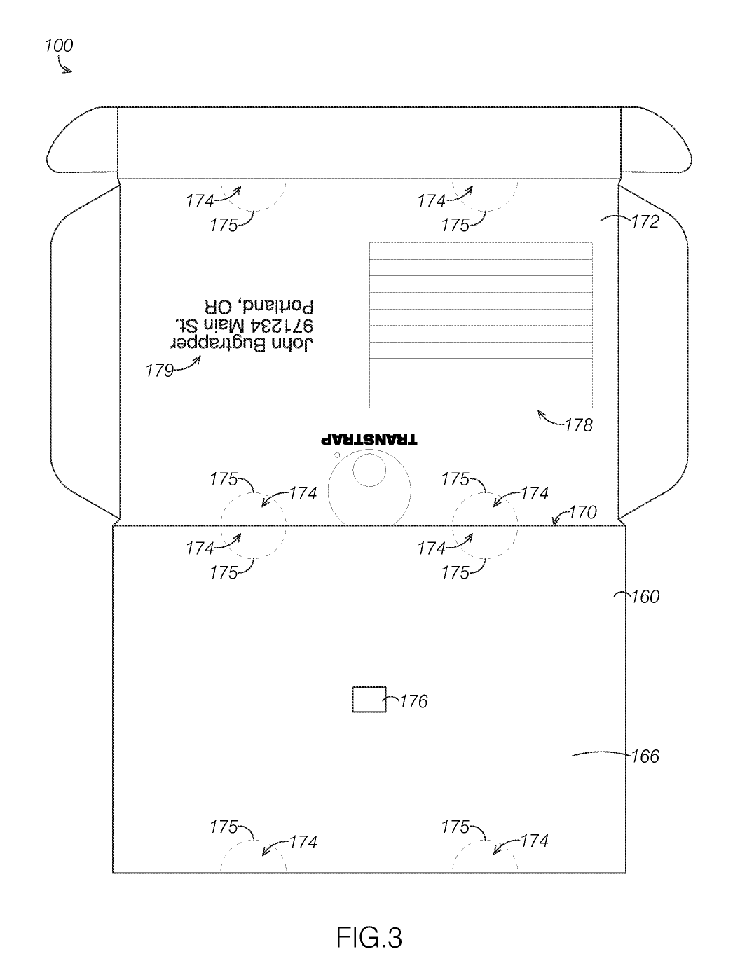

As FIG. 3 shows, container 160 may include space on its exterior for a user to record information relevant to the shipment and/or to detecting pests. Because shipping containers are often in transit for a long time, device 100 is configured to lure and trap pests for extended periods of time. Being configured to accommodate longer luring and trapping times enables device 100 to provide more accurate and complete pest detection capabilities.

As FIG. 1 illustrates, container 160 defines a box defining a container surface 162 and a rim 168 projecting from container surface 162. Container surface 162 and rim 168 cooperate to enclose a contained volume 164. Rim 168 provides an opening 169 to contained volume 164 opposite container surface 162. In the example shown in FIG. 1, sheet 110 is engaged with container surface 162 within contained volume 164.

As shown in FIG. 3, container 160 defines a back surface 166 opposite container surface 162. With reference to FIG. 1, the reader can see that container 160 includes a cover 172, a fastener 176, a content data form 178, and a shipping data form 179.

With reference to FIGS. 1 and 3, cover 172 defines a flap extending from a flap junction 170 adjacent rim 168. Cover 172 adjusts container 160 between an open configuration exposing opening 169 to a closed configuration closing opening 169 by selectively rotating cover 172 around flap junction 170. When container 160 is in an open configuration, pests may come into contact with, and often adhere to, adhesive sheet 110. When container 160 is in a closed configuration, container 160's contents, including any trapped pests, may be transported for shipping or analysis.

As FIG. 3 illustrates, fastener 176 is attached to an exterior of container 160 on back surface 166. As FIG. 3 shows, fastener 176 defines a hook and loop fastening strip configured to pair with a complimentary strip to mount on a wall. For example, FIG. 2 illustrates pest detecting and trapping device 100 mounted to a support 105 defining the wall of shipping container 104 by pairing fastener 176 to a complimentary hook and loop fastener on the wall of shipping container 104.

A hook-and-loop fastener is not a required feature of pest trapping and detecting devices disclosed herein, however. A wide variety of fasteners are suitable, for example, the device may include lines extending from the top of the container to be fastened to a wall or ceiling. In other examples, the device includes mechanical fasteners, such as nails and screws, for mounting to a wall.

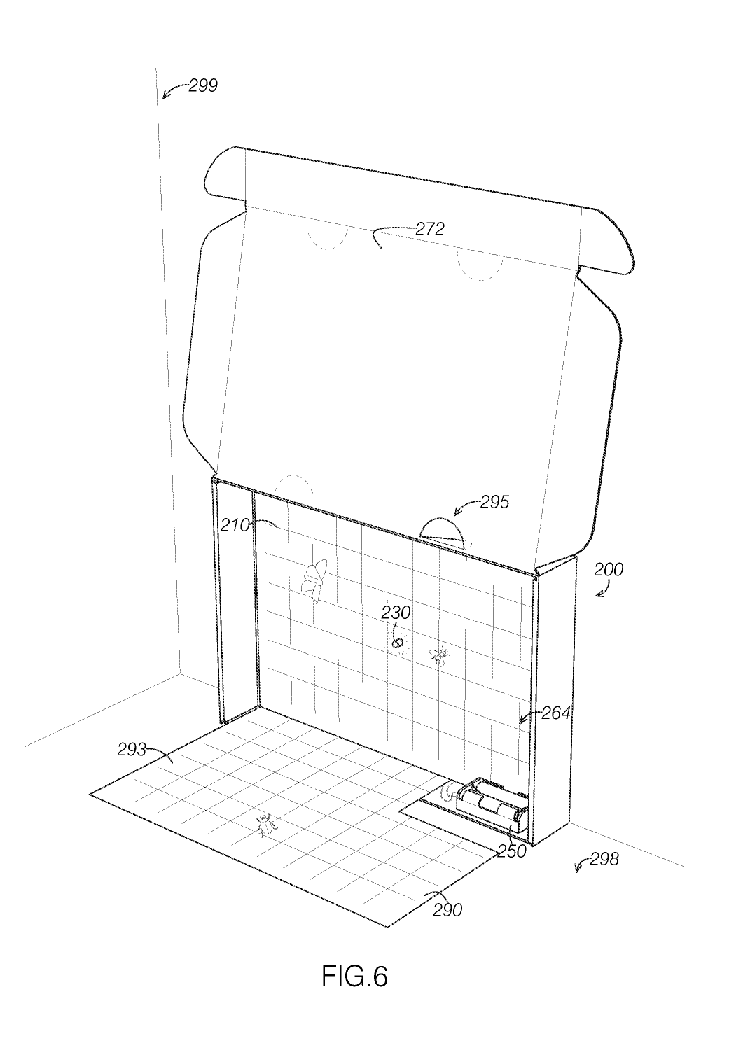

While fasteners may be useful for elevating the device off of the ground or for better maintaining the device in a static position, this disclosure specifically contemplates pest trapping devices without fasteners. In pest trapping device examples without fasteners, the device may be used, for example, on the floor of a shipping container. FIG. 6 shows an example of a pest trapping and detecting device 200 that does not include a fastener.

With reference to FIG. 3, container 160 includes selectively removable areas 174 defining areas on container 160 enclosed by a perforated perimeter 175. By removing selectively removable areas 174, a user may define an opening to contained volume 164 while container 160 remains in a substantially closed configuration.

When pest detecting and trapping device 100 is configured with area 174 removed, device 100 may continue to capture pests while minimizing environmental exposure to previously captured pests. Selectively removable areas 174 are shown on the cover of device 100 in FIGS. 1-3; this disclosure, however, equally considers selectively removable areas positioned on any portion of container 160. In some examples, the selectively removable areas may be reattached to containers, thereby allowing the container to be fully closed after use.

As FIG. 3 shows, container 160 includes two spaces for data entry on its exterior: content data form 178 and shipping data form 179. In content data form 178, certain information and/or statistics about the contents and use of container 160 may be indicated. For example, a user may record information corresponding to an amount of trapped pests within container 160, shipper information, consignee information, bill of landing number, container number for the shipping container in which container 60 was used, dates container 60 was use, a name of a vessel on which container 160 was contained, a point of origin, ports traveled between, destination information, and details about a commodity contained within the shipping container.

The data recorded on content data form 178 may be used as a quick reference to make sorting and analyzing pest detecting and trapping device 100 easier when it arrives at a given destination. The data recorded on content data form 178 may be viewed without opening container 160, thereby reducing the risk of potentially damaging contained pests and tarnishing detected results in sorting and analysis tasks.

Shipping data form 179 includes similarly accessible data relevant to shipping container 160. Shipping data form 178 allows container 160 and contained pests to be shipped in a substantially unmodified state. In some circumstances, shippers include their own address or a third-party's address on form 179. Form 179 may be particularly useful for sending shipping container 160 to third parties to analyze the contents of device 100.

Container 160, as shown in FIGS. 1-3, is relatively small in size and may be positioned in shipping containers in a substantially non-intrusive manner. In the present example, container 160 is constructed of a lightweight cardboard, making it inexpensive to manufacture and lightweight.

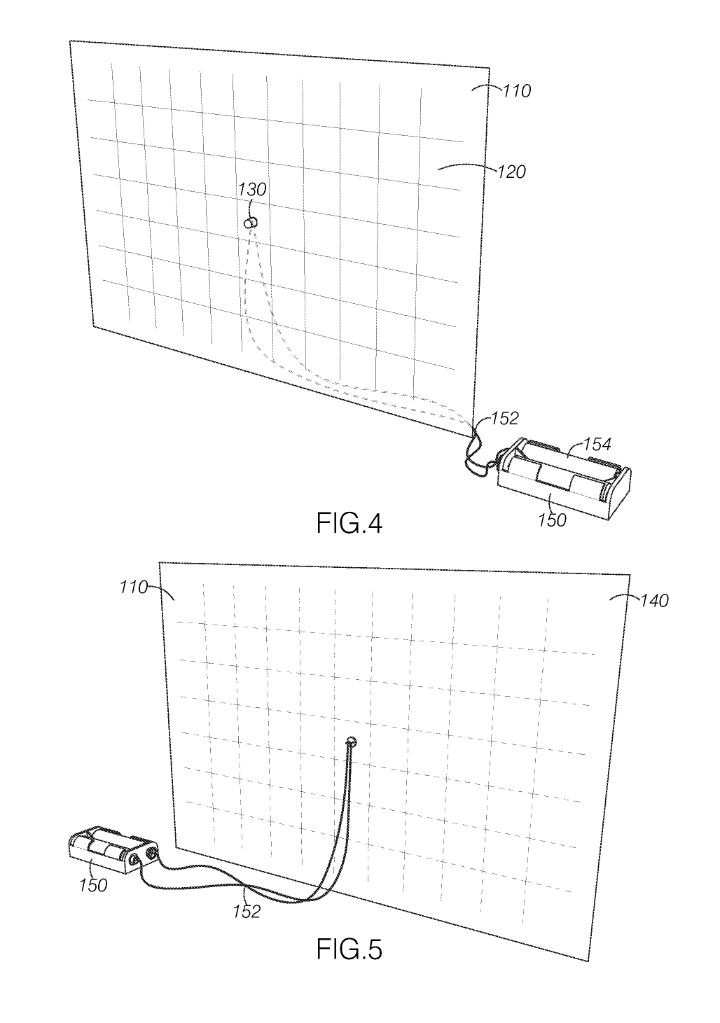

As FIG. 1 illustrates, sheet 110 is engaged with container surface 162 within contained volume 164. With reference to FIGS. 4 and 5, sheet 110 defines an aperture 123, a rear surface 140, and an adhesive surface 120. Sheet 110 is configured to trap pests within container 160 when pests contact sheet 110. Sheet 110 traps pests within container 160, which non-destructively removes the pests from the shipping container's environment while storing them in a container for easy transport and analysis.

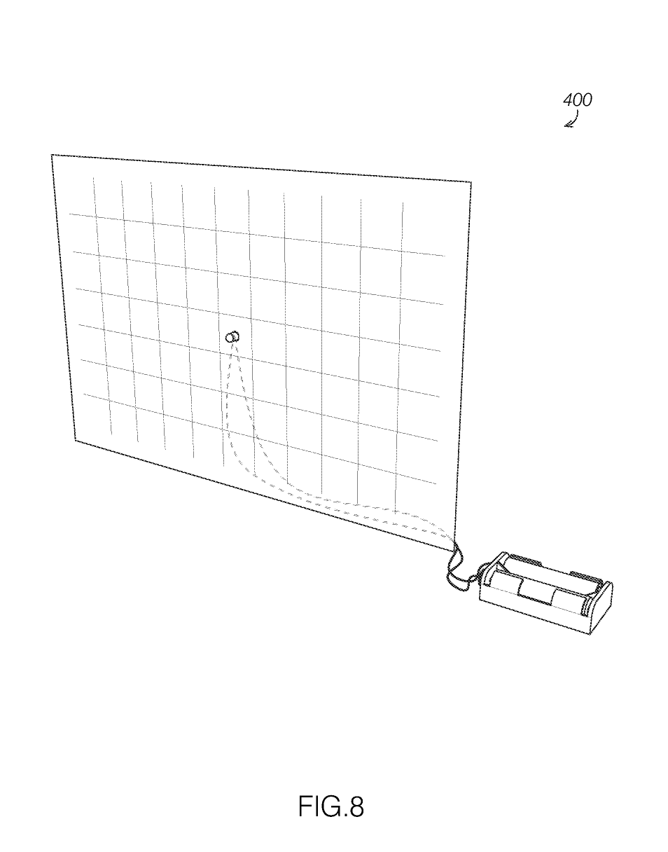

FIGS. 1-3 shows pest detecting and trapping device 100 in a configuration where sheet 110 is contained within contained volume 164, but this is not specifically required. Indeed, in some examples the device includes a sheet, a power source, and a light source, but does not include a container similar to container 160. For example, FIG. 8 illustrates an example of a device 400 including a sheet, a power source, and a light source independent of a container.

Adhesive surface 120 includes an adhesive selected to trap pests when they contact the adhesive. In particular, the adhesive is selected to trap pests in a substantially non-destructive manner. In some examples, the adhesive is selected to trap small pests, like insects, bugs, and other small animals. Additionally or alternatively, the adhesive may be selected to trap other pests, such as rats, other rodents, or other larger animals.

In some examples, a chemical attractant 122, such as a pheromone, is applied to adhesive surface 120 to further attract pests to the surface. The chemical attractant may include a plant-based or food-based kairomone. In additional or alternative examples, the chemical attractant may include a sex pherenome and/or a plant-based attractant.

Adhesive surface 120 retains pests in a static position after trapping them. As a result, adhesive surface 120 provides a simple snapshot of pests trapped during use. The snapshot of trapped pests provides a convenient method for detecting pests. Indeed, a user may readily inspect the type and quantity of pests trapped on adhesive surface 120 for purposes of acquiring data about pests within the general vicinity of device 100, such as within a shipping container. In some examples, a user may write or mark on adhesive surface 120 to help with the process of detecting and/or analyzing pests.

In addition to chemical attractants, this disclosure contemplates applying other additional or alternative supplemental substances, such as poisons, to adhesive surface 120.

As FIG. 4 shows, sheet 110 defines rear surface 140 opposite adhesive surface 120. In certain examples, the rear surface includes adhesives used for adhering to a supporting surface or trapping additional pests.

As FIG. 1 shows, aperture 123 extends through sheet 110. Aperture 123 allows light source 130 to extend through sheet 110 and extend above adhesive surface 120. As can be seen in FIG. 4, light source 130 connects to power source 150 via a wire 152 routed on the rear surface 140 side of sheet 110. By routing wire 152 on the rear surface side of sheet 140, wire 152 is less likely to unintentionally contact adhesive surface 120.

As FIG. 1 illustrates, light source 130 mounts to sheet 110 by extending through aperture 123 and above adhesive surface 120. In this position, light source 130 provides an illumination source visible from the adhesive surface side of sheet 110. Light source 130 includes a light-emitting diode 132 configured to project light away from adhesive surface 120 and lure pests toward adhesive surface 120.

Although this disclosure is not limited to devices including a light source serving as a lure, there are particular benefits to using a light source as a lure in shipping container contexts. Because shipping containers are an unnatural environment, being dark, sealed, and having little air movement, pests are very likely to orient to a light source under these conditions. While other lures, such as chemical attractants, may also be used to lure pests, their efficacy may be more species-specific than light-sources. As a result, light-source based lures, such as light source 130, may attract a wider variety of pest species. Because shipping containers often contain an unpredictable array of pests, using a light source, which is more species-agnostic, may be preferred in shipping container contexts compared to other lures.

Although light source 130 may project visual light, this is not specifically required. For example, in some examples the device includes light sources that emit light wholly or partially outside the visual spectrum. Applicants have observed that light outside the visual spectrum, such as light from the ultra-violet range of wavelengths, effectively attracts pests to the adhesive surface.

In some examples, the device includes multiple light sources mounted to the sheet in a position to emit light on the adhesive surface side of the sheet. Each light source may emit light from both visual and non-visual spectrums or some light sources may emit visible light while others emit light outside the visible spectrum.

In the example shown in FIGS. 1-5, light source 130 includes a light-emitting diode 132. Light emitting diodes may be advantageous in certain applications due to their relatively small size and low power consumption. The low power consumption of a light-emitting diode allows light source 130 to remain illuminated for long periods, which is conducive to shipping.

For example, some tested light-emitting diodes were able to sustain illumination for 30 consecutive days on two AA disposable batteries. The small size of light-emitting diode 132 limits how much it intrudes on the trapping surface of adhesive surface 120. Other light sources beyond light emitting diodes may be uses, however. Additional or alternative light sources may include, for example, compact fluorescent or incandescent bulbs.

The light source may be selected to emit light of a selected wavelength or range wavelengths to improve the ability of light source to attract a particular type of pest. Table 1, illustrated bellow, shows several examples of wavelengths or colors that may be selected to attract a selected pest.

TABLE 1

| Selected Pest | Wavelength Range (nm)/Color |
|---|---|
| Emerald Ash Borer | 400-420 |
| Basswood Thirps, Uzel, Pear Thrips | Yellow (~570-590) |
| Tobacco Hawkmouth | 450-560 |
| Flea Beetle | 350-430 |
| Coccinella and Cicindela Beetles | 360-380, 510-530 |
| Glow Worm | 555 |
| Amphicoma Beetles | Red (~620-750) |
| Apple Blossom Weevil | Ultraviolet (<380), |
| | Green (~495-570), |
| | Blue (~450-475) |
| Western Flower Thrips | 440-480, 365, 540 |
| Glasshouse Whitefly | 520-610, 360-380 |
| Sweetpotato Whitefly | Ultraviolet (<380), |
| | Blue (~450-475), |
| | Yellow (~570-590) |
| Silverleaf Whitefly | 490-600 |
| Leafhopper | 490-600 |

Several of these wavelength examples above have been tested with the associated pests by the inventors or by an unaffiliated third-party. The tests demonstrated that the associated pest responds particularly well to light at the indicated wavelength(s).

As FIG. 4 shows, power source 150 is spaced from sheet 110 and is electrically connected to light source 130. By spacing power source 150 from sheet 110, sheet 110 is able to support light source 130 without also needing to support power source 150.

In examples where the device includes a container, such as pest detecting and trapping device 100 used in the example shown in FIGS. 1-3, power source 150 may be attached to the container. Power source 150 may attach to container 160 either within contained volume 164 or on the exterior of container 160.

As FIG. 4 illustrates, power source 150 includes a pair portable batteries 154. The batteries may be disposable and/or may be rechargeable. In other examples, however, the power source may define an external power source, such as an alternating current or direct current electrical outlet.

As FIGS. 4 and 5 illustrate, wire 152 extends from light source 130 to power source 150 to provide electrical power to light source 130 from power source 150. As FIG. 4 shows, wire 152 is routed through aperture 123, allowing wire 152 to be routed proximate rear surface 140. Routing wire 152 proximate rear surface 140 may inhibit or prevent wire 152 from unintentionally engaging with, and sticking to, adhesive surface 120.

Turning to FIG. 6, a second example of a pest detecting and trapping device, device 200, will now be described. As FIG. 6 shows, device 200 includes many similar or identical features to pest detecting and trapping device 100. Thus, for the sake of brevity, each feature of device 200 will not be redundantly explained. Rather, key distinctions between device 200 and pest detecting and trapping device 100 will be described in detail and the reader should reference the discussion above for features substantially similar between the two devices.

As FIG. 6 illustrates, device 200 includes a container 260, defining a contained volume 264 and including a cover 272, a power source 250, and a light source 230, each substantially similar to corresponding elements of pest detecting and trapping device 100.

As FIG. 6 illustrates, device 200 includes a two sheets, including a first sheet 210 and a second sheet 290, rather than the single sheet included in pest detecting and trapping device 100. As FIG. 6 shows, first sheet 210 is substantially similar to sheet 110 and is similarly contained within container 260.

Second sheet 290 includes an adhesive surface 293 on the side of second sheet 290 proximate first sheet 210. Like adhesive surface 120, adhesive surface 293 is similarly configured to trap and detect pests. As FIG. 6 shows, however, second sheet 290 is supported by first sheet 210 and extends to align with cover 272 proximate a floor 298 of a shipping container 299. In the configuration shown in FIG. 6, second sheet 290 is better able to detect and trap walking and/or crawling pests, such as centipedes and millipedes. Because second sheet 290 is aligned with cover 272 on the side proximate container volume 264, any pests trapped by second sheet 290 may be contained within contained volume 264 by closing cover 272.

As FIG. 6 illustrates, second sheet 290 may additionally include a removed area 295. In some examples, removed area 295 may be configured to allow power source 250 to attach directly to container 260 without second sheet 290 interfering. In other examples, however, removed area 295 of may be aligned with a selectively removable area on the container's cover.

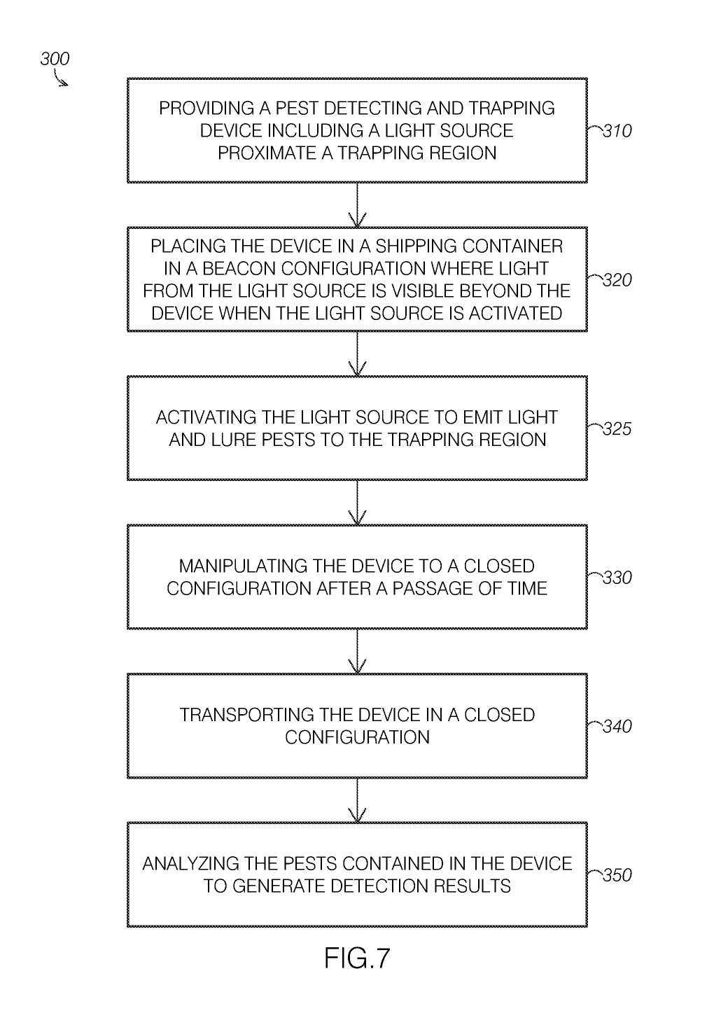

Turning to FIGS. 7 and 8, an example of a method to detect and trap pests in a shipping container with a pest trapping and detecting device including a light source, method 300, will now be described. As FIG. 7 illustrates, method 300 includes the steps of providing a pest detecting and trapping device including a light source proximate a trapping region at step 310, placing the device in a shipping container in a beacon configuration where light from the light source is visible beyond the device when the light source is activated at step 320, activating the light source to emit light and lure pests to the trapping region at step 325, manipulating the device to a closed configuration after a passage of time at step 330, transporting the device in a closed configuration at step 340, analyzing the pests contained in the device to generate detection results at step 350.

Providing a pest detecting and trapping device including a light source proximate a trapping surface at step 310 includes providing any suitable pest detecting and trapping device disclosed herein, expressly or inherently, and any variations within the scope of this disclosure. For example, step 310 may include providing device 100 or device 200 discussed above. Both device 100 and device 200 include light sources proximate trapping regions. Additionally or alternatively to devices 100 and 200, step 310 may include providing a wide variety of other suitable pest detecting and trapping devices including light sources proximate trapping regions.

Placing the device in a shipping container at step 320 enables the device to trap pests as the shipping container is transported. The beacon configuration enables the light source to lure pests to the trapping region. With reference to the devices disclosed above, including devices 100 and 200, placing the device in a beacon configuration may include opening a container to expose the light source and the trapping surface. Additionally or alternatively, placing the device in a beacon configuration may include removing a removable portion from the container to define a window through which light may extend beyond the device and through which pests may enter the device.

Activating the light source to emit light at step 325 serves to lure pests to the trapping region. In some examples, activating the light source includes leaving the light source activated for a relatively long, continuous duration, such as substantially the entire time a shipping container is in transit. In other examples, activating the light source includes selectively activating the light source for discrete activated time intervals and selectively deactivating the light source for discrete deactivated time intervals. Activated time intervals may define a periodic schedule or may be a variable time interval dependent on other factors, such as when the ambient conditions are dark, a selected temperature range, a selected humidity, and the like.

Activating the light source at step 325 may be accomplished by any conventional means. For example, activating the light source may include connecting the light source to a power supply or manipulating a switch connecting the light source to a power supply. In some examples, activating the light source includes a user manually connecting the light source to a power source, directly or via a switch, and in other examples it includes a user remotely connecting the light source to a power supply, directly or via a switch. In still further examples, the light source is programmed to activate on a set schedule or in response to set conditions.

By manipulating the device to a closed configuration at step 330, the device is able to protect pests trapped within the device from the elements. Protecting the trapped pests from the elements helps reduce the likelihood of damage to the pests, which interfere with subsequent analysis of the pests. At this point, a user may additionally add data to shipping data form 179 and content data form 178. The entered data may be used for sorting and analyzing the container and/or detected pests.

Allowing the device to remain open for a passage of time enables the device to lure and trap at least a portion of the pests present in the shipping container. Allowing the device to remain open for a longer period of time has been observed to lure and trap more pests within the device. The amount of pests trapped within the device over a given period of time is taken to be a representative sample of the total quantity of pests in the shipping container.

Transporting the device in a closed configuration at step 340 may include transporting the device to any desired location. For example, the device may be transported to a facility for sorting and/or storing the trapped pests or the device as a whole. Additionally or alternatively, transporting the device may include transporting it to a facility for analyzing the trapped pests.

Analyzing the pests contained in the device to generate detection results at step 350 may include any conventional or later developed technique for analyzing pests. For example, analyzing the trapped pests may include determining the quantity of pests and/or the type of pests. Additionally or alternatively, analyzing the pests may include determining the age, sex, and/or sexual maturity of the trapped pests. The generated detection results may include this data, along with any other relevant data calculated based on this data.

The analysis at step 350 may be conducted at the location where the device was deployed or may be conducted elsewhere, such as a remote location. Generating detection results may involve tabulating the data, entering the data into a database, and/or reporting data to a party interested in the results of the analysis. Generating detection results may include entering pest detection data on a data entry form on the device.

Over time, detection results may be correlated with related detection results (such as from a prior shipment). By comparing these sets of data, the shipper may be able to determine pest prevalence within its shipments and provide a clearer picture as which pests tend to be present in a given shipment type or category. The detection results may enable a shipper to predict the quantity and/or type of pests likely to be encountered with respect to particular containers, geographic areas, ports, or times of year. With these results, a user is able to respond to the particular conditions and reduce the prevalence of pests during shipments, thereby providing higher quality cargo.

Many of the devices and methods described herein are particularly applicable to trapping and monitoring insects. Insects are not, however, the only type of pest contemplated to be trapped and monitored. For example, certain devices may be particularly tailored for use in trapping and monitoring other small animals, such as spiders, scorpions, and other arthropods. Other devices and methods examples may be configured to trap larger animals, such as rodents, snakes, or other larger vertebrate animals.

Additionally, this disclosure discusses insect-trapping sheets and/or adhesives. Suitable adhesives are not limited to adhesives commonly used or known to be used for trapping insects. Rather, suitable adhesives include any adhesive of sufficient strength to trap an insect.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An pest detecting and trapping device, comprising:
an insect-trapping sheet defining an adhesive surface;
a light source supported proximate the adhesive surface of the insect-trapping sheet; and
a power source configured to deliver power to the light source.

2. The pest detecting and trapping device of claim 1, wherein the power source is spaced from the insect-trapping sheet; and the pest detecting and trapping device further comprises:
an aperture extending through the insect-trapping sheet; and
a wire electrically connecting the light source to the power source, the wire extending through the aperture.

3. The pest detecting and trapping device of claim 2, wherein the light source extends through the aperture and is at least partially supported within the aperture.

4. The pest detecting and trapping device of claim 1, wherein the light source includes a light-emitting diode.

5. The pest detecting and trapping device of claim 4, wherein the light source produces light of a wavelength selected to attract a selected pest.

6. The pest detecting and trapping device of claim 1, further comprising a container defining an interior surface, wherein the insect-trapping sheet is supported proximate the interior surface.

7. The pest detecting and trapping device of claim 6, further comprising a rim projecting from the interior surface, the rim enclosing an contained volume; wherein the insect-trapping sheet is positioned within the contained volume.

8. The pest detecting and trapping device of claim 7, wherein the container includes a cover configured to selectively engage with the rim to cover at least a portion of the contained volume.

9. The pest detecting and trapping device of claim 6, wherein the container includes a selectively removable area configured to be removed and to provide an opening to the contained volume.

10. The pest detecting and trapping device of claim 6, further comprising a fastener attached to the container to mount the container to a support.

11. The pest detecting and trapping device of claim 1, further comprising an insect poison applied to the insect-trapping sheet.

12. The pest detecting and trapping device of claim 1, further comprising a chemical attractant applied to the insect-trapping sheet.

13. The pest detecting and trapping device of claim 12, wherein the chemical attractant includes a kairomone.

14. The pest detecting and trapping device of claim 1,
wherein:
the insect-trapping sheet defines a first insect-trapping sheet, and
the adhesive surface defines a first sheet adhesive surface; and
further comprising a second insect-trapping sheet extending from the first insect-trapping sheet, the second insect-trapping sheet defining a second sheet adhesive surface proximate the first sheet adhesive surface.

15. A method for a shipper to detect and trap pests in a shipping container, the method comprising the steps of:
providing a pest detecting and trapping device, the pest detecting and trapping device including:
a container configured to be selectively placed in an open configuration where pests can enter the container and a closed configuration covering the container;
an adhesive surface disposed within the container; and
a light source supported proximate the adhesive surface;
placing the pest detecting and trapping device in the shipping container in a beacon configuration where light from the light source is visible beyond the device when the light source is activated; and
activating the light source.

16. The method of claim 15,
wherein:
the container is configured to be selectively placed in an open configuration where pests can enter the container and a closed configuration covering the container, and
placing the pest detecting and trapping device in the shipping container includes placing the pest detecting and trapping device in the shipping container in the open configuration; and
further comprising manipulating the pest detecting and trapping device into the closed configuration after a passage of time.

17. The method of claim 15, further comprising transporting the device in a closed configuration to a remote facility.

18. A method for a shipper to detect and trap pests in a shipping container, the method comprising the steps of:
providing a pest detecting and trapping device, the pest detecting and trapping device including:
a container enclosing a contained volume, the container including:
an opening, and
a removable cover configured to cover at least a portion of the opening;
an adhesive surface disposed within the container; and
a light source supported proximate the adhesive surface;
placing the pest detecting and trapping device in the shipping container in a beacon configuration where the opening is at least partially not covered by the removable cover and light from the light source is visible beyond the device when the light source is activated; and
manipulating the pest detecting and trapping device into a closed configuration after a passage of time.

19. The method of claim 18, further comprising the step of transporting the container after the passage of time.

20. The method of claim 18, further comprising the step of analyzing the quantity or type of pests contained within the pest detecting and trapping device after the passage of time to produce detection results.
